(19) United States
(12) Patent Application Publication
(10) Pub. No.: US 2015/0003048 A1
(43) Pub. Date: Jan. 1, 2015

(54) MOTION-ACTIVATED MEDICAL/DENTAL HEADLAMP

(71) Applicant: Byung J. Chang, Ann Arbor, MI (US)

(72) Inventor: Byung J. Chang, Ann Arbor, MI (US)

(73) Assignee: General Scientific Corporation, Ann Arbor, MI (US)

(21) Appl. No.: 13/929,394

(22) Filed: Jun. 27, 2013

(51) Int. Cl. F21V 33/00; F21L 4/00

(52) U.S. Cl. CPC F21V 33/0068; F21L 4/00
USPC 362/105

(57) ABSTRACT

A headlight incorporates an infrared sensor enabling the light to be turned ON and OFF without physical contact. The system includes a light source and a mechanism for coupling the light source to eyeglass frames or to a headband. A power supply and control unit is disposed remotely from the light source and is interconnected to the light source through an electrical cable. An infrared (IR) motion sensor is interconnected to the power supply and control unit, and electrical circuitry within the power supply and control unit is operative to turn the light source ON and OFF is response to the detection of a hand or other body part by the sensor. In the preferred embodiment, the light source includes a light-emitting diode (LED), and the IR detector is a passive IR pyroelectric sensor. The IR sensor may be attached to clothing, eyeglass frames, a headband, or the light source itself.

### FIELD OF THE INVENTION

This invention relates generally to headlights of the type used by surgeons, medical and dental practitioners and, in particular, to a motion-activated headlamp.

### BACKGROUND OF THE INVENTION

It is common for surgeons and medical/dental practitioners to wear headlights to enhance vision. Typical headlights using light-emitting diodes and optical fibers may be found at http://surgitel.com/headlights.

With such systems, the headlight contains only the light source and beam-forming optics. The power supply is disposed remotely, and may be belt-worn, for example.

One of the problems with existing systems is that the control unit may not be sterilized, such that the practitioner's hand may become contaminated if the light is turned ON or OFF during a procedure.

### SUMMARY OF THE INVENTION

This invention is directed to a headlight with an infrared sensor enabling the light to be turned ON and OFF without physical contact. The system includes a light source and a mechanism for coupling the light source to eyeglass frames or to a headband. A power supply and control unit is disposed remotely from the light source and is interconnected to the light source through an electrical cable. An infrared (IR) motion sensor is interconnected to the power supply and control unit, and electrical circuitry within the power supply and control unit is operative to turn the light source ON and OFF is response to the detection of a hand or other body part by the sensor.

In the preferred embodiment, the light source includes a light-emitting diode (LED), and the IR detector is a passive or an active IR sensor. A mechanism may be provided to attach the IR sensor to clothing, the IR sensor to the eyeglass frames, the headband, or the light source. The light source and IR sensor may be interconnected to an electrical coupler through separate cables, with a combination cable being used to interconnect the light source and IR sensor to the power supply and control unit through a single combination cable.

### BRIEF DESCRIPTION OF THE DRAWINGS

FIG. 1 is a drawing of an embodiment of the invention using an eyeglass frame mounted headlight;

FIG. 2 is a drawing of an embodiment of the invention using headband-mounted headlight; and

FIG. 3 is a block diagram of the invention showing cables, light emitter, and sensor.

### DETAILED DESCRIPTION OF THE INVENTION

This invention is directed to a headlight with an infrared sensor enabling the light to be turned ON and OFF without physical contact. As such, the invention is ideally suited for surgical, medical and dental applications wherein a sterile field may be compromised through manual contact. While in the preferred embodiments the light source comprises one or more light-emitting diodes (LEDs), the invention is not limited in terms of the light source used.

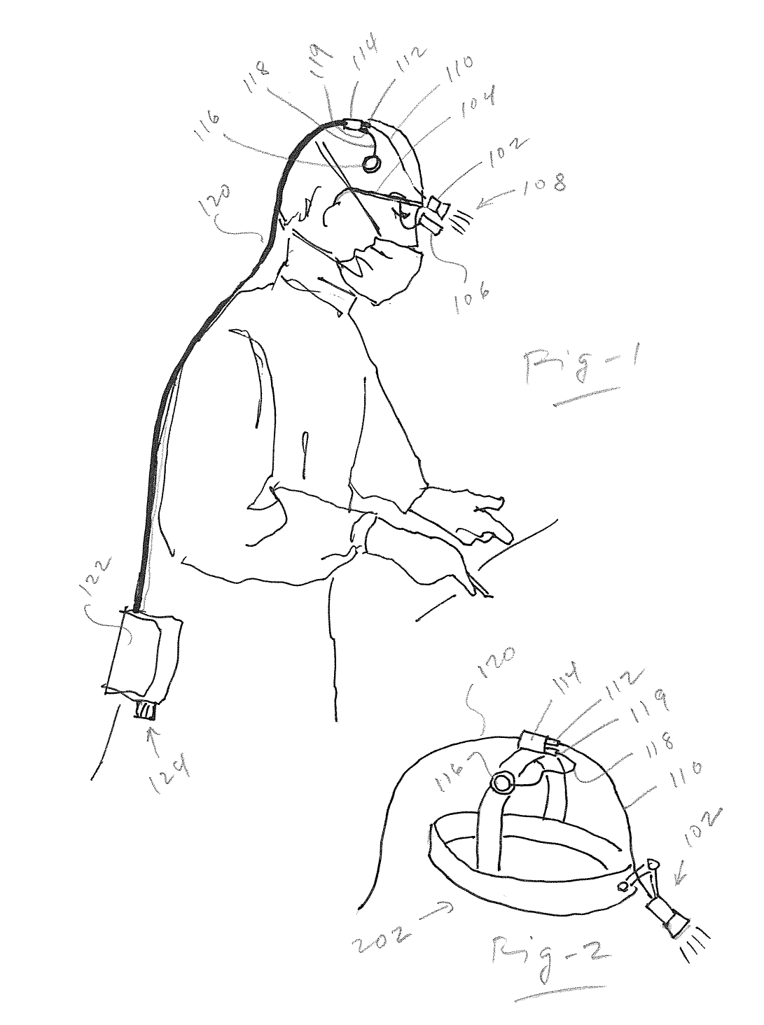

FIG. 1 is a drawing of an embodiment of the invention using an LED headlight 102 mounted to eyeglass frames 104. In all embodiments, the light source may be permanently connected or temporarily coupled by way of a clip-on structure. Loupes 106, either the flip-up type or through-the-lens (TTL) type may be provided in conjunction with light source 102.

The light source 102 includes beam-forming and/or focusing optics (not shown) to produce a desired beam pattern 108. The LED(s) are powered through cable 110 which is ultimately connected to remote power supply and controller 122, which may be belt-worn, through combination cable 120. The system also includes an infrared (IR) sensor module 116 that is also coupled to the power supply and controller 122 through combination cable 120.

While the light 102 and IR sensor may be connected to the unit 122 directly, in the preferred embodiment, cable 110 from the light connects to a coupling unit 114 through electrical connector 112, and cable 118 from the sensor connects to the coupling unit 114 through electrical connector 119, enabling either or both of the cables 110, 118 to be disconnected. The power supply and control unit 122 contains rechargeable batteries that are replenished via connect to a changer shown in the block diagram of FIG. 3. A manual control knob 124 may be provided to establish a desired level of brightness prior to ON/OFF control using the IR sensor.

IR sensor 116 is preferably a miniature passive IR sensor available from various suppliers. For example, the KC7783 PIR Sensor Module is a pyroelectric sensor module developed for human body part detection. A PIR detector, combined with a Fresnel lens, are mounted on a compact printed circuit board together with an analog IC (the KC778B) providing a TTL output that can be directly connected to a microcontroller or logic device disposed in remote unit 122. Again, this PIR sensor is one of many applicable to the invention.

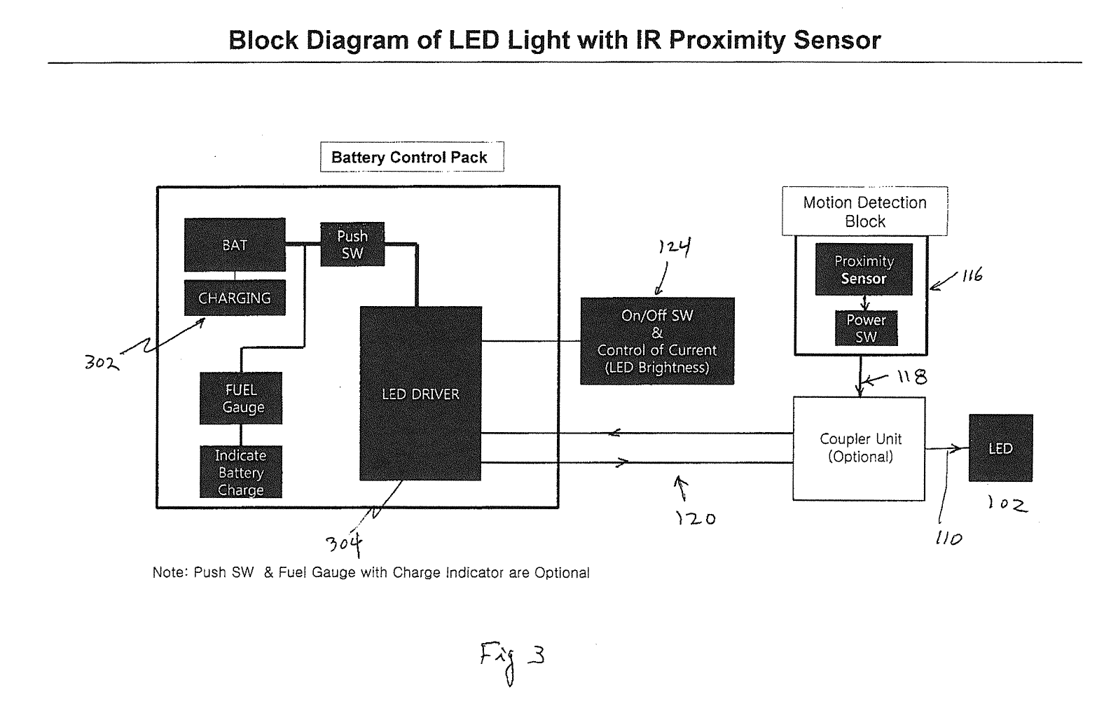

The IR sensor may be mounted at any convenient location, though in the preferred embodiment, it is head-mounted, whether clipped to a head mask or other clothing, mounted on eyeglass frames, the light source itself, or a headband 202 of the type depicted in FIG. 2. The sensor is preferably oriented in a direction that is least likely to experience false activation from bright/warm lights, other individuals, and so forth.

In operation, a user waves their hand in the proximity of the sensor 116, which causes the light 102 to turn ON and OFF without physical contact. In the preferred embodiment, the detection distance of the sensor is adjusted to be on the order of about 5 to 10 cm to enhance proper operation. This activation distance, as well as the field of view, may be adjusted through electrical component selection and/or sensor lens optics, materials, translucency, and so forth.

Referring to FIG. 3, the electrical circuitry 304 in the power supply and control unit 122 may be designed to simply toggle the light ON/OFF with each hand/body part detection. In other words, if the light is ON, the user waves their hand to turn it OFF and vice-versa. Further, if the light is ON or OFF by mistake, one wave of the hand resents the light to the correct activation.

1. A motion-activated headlamp, comprising:
a light source;
a mechanism for coupling the light source to eyeglass frames or to a headband;
a power supply and control unit disposed remotely from the light source, and interconnected to the light source through an electrical cable;
an infrared (IR) motion sensor interconnected to the power supply and control unit; and
electrical circuitry within the power supply and control unit operative to turn the light source ON and OFF is response to the detection of a hand or other body part by the sensor.

2. The motion-activated headlamp of claim 1, wherein the light source includes a light-emitting diode (LED).

3. The motion-activated headlamp of claim 1, including a passive or an active IR sensor.

4. The motion-activated headlamp of claim 1, including a mechanism to attach the IR sensor to clothing.

5. The motion-activated headlamp of claim 1, including a mechanism to attach the IR sensor to the eyeglass frames, the headband, or the light source.

6. The motion-activated headlamp of claim 1, wherein:
the light source and IR sensor interconnect to an electrical coupler through separate cables; and
a combination cable interconnecting the light source and IR sensor to the power supply and control unit through a single combination cable.
